(19) United States
(12) Patent Application Publication
(10) Pub. No.: US 2015/0069656 A1
(43) Pub. Date: Mar. 12, 2015

(54) SYSTEMS AND METHODS FOR MANUFACTURING CONCRETE STRUCTURES

(71) Applicant: Elwha, LLC, Bellevue, WA (US)

(72) Inventors: Jeffrey A. Bowers, Bellevue, WA (US); Bran Ferren, Beverly Hills, CA (US); W. Daniel Hillis, Encino, CA (US); Roderick A. Hyde, Redmond, WA (US); Cameron A. Myhrvold, Bellevue, WA (US); Conor L. Myhrvold, Bellevue, WA (US); Nathan P. Myhrvold, Bellevue, WA (US); Clarence T. Tegreene, Mercer Island, WA (US); Lowell L. Wood, JR., Bellevue, WA (US)

(21) Appl. No.: 14/020,636

(22) Filed: Sep. 6, 2013

(51) Int. Cl. B28B 1/16; B28B 13/02

(52) U.S. Cl. CPC B28B 1/16; B28B 13/021
USPC 264/241; 425/470

(57) ABSTRACT

The embodiments disclosed herein relate to construction systems, assemblies, and methods. The construction systems can include concrete dispensing assemblies. The concrete dispensing assemblies can be configured to dispense a plurality of discrete units. The concrete dispensing assemblies can also be configured to simultaneously dispense two or more concrete mixtures. One or more dispensing parameter may be controllable, for example, by a computer control system. Additives and/or curing agents may also be used. Exemplary curing agents include carbon dioxide containing materials.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

None

### RELATED APPLICATIONS

U.S. patent application Ser. No. ______, entitled SYSTEMS AND METHODS FOR MANUFACTURING CONCRETE STRUCTURES, naming Jeffrey A. Bowers, Bran Ferren, W. Daniel Hillis, Roderick A. Hyde, Cameron A. Myhrvold, Conor L. Myhrvold, Nathan P. Myhrvold, Clarence T. Tegreene and Lowell L. Wood, Jr. as inventors, filed Sep. 6, 2013, with attorney docket no. 46076/117, is related to the present application.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### TECHNICAL FIELD

The present disclosure relates generally to systems and methods for manufacturing concrete structures. More particularly, the present disclosure relates to systems and methods for dispensing concrete mixtures.

### SUMMARY

The embodiments disclosed herein relate to construction systems, assemblies, and methods. For example, in various embodiments, the disclosed systems and methods can be used for manufacturing concrete structures. In some embodiments, the disclosed systems and methods comprise a concrete dispensing assembly. The concrete dispensing assembly can be configured to dispense a plurality of discrete units. In other embodiments, the concrete dispensing assembly is configured to simultaneously dispense two or more different concrete mixtures.

The concrete dispensing assemblies can comprise various components. In some embodiments, the concrete dispensing assembly comprises a dispensing head. For example, the dispensing head can be an extrusion head, a pour head, a spray head, or a rotary head. Other types of dispensing heads can also be used.

In some embodiments, the dispensing head is configured to shape or form the mixtures that are being dispensed. The concrete dispensing assemblies can further comprise one or more additional shaping devices. The shaping devices may be coupled to the dispensing head. In some embodiments, the shaping device comprises a removable face plate. In some embodiments, the shaping device comprises one or more trowels.

The disclosed concrete dispensing assemblies can be controllable. In some embodiments, for example, the concrete dispensing assemblies can comprise a computer control system. The computer control system can comprise one or more processors. Further, the computer control system can comprise a user interface.

The concrete dispensing assemblies can further comprise an orientation control mechanism. In some embodiments, the orientation control mechanism is coupled to the computer control system. The orientation control mechanism can be configured to control movement of the concrete dispensing assemblies in three dimensions. For example, the orientation control mechanism may control movement along the X, Y, and Z axes.

Additives and/or curing agents may also be used in the embodiments disclosed herein. In some embodiments, the additives and/or curing agents can comprise carbon dioxide. For example, in some embodiments, the additives and/or curing agents comprise dry ice. In other embodiments, the additives and/or curing agents comprise carbon dioxide clathrate. Other additives and/or curing agents can also be used.

The additives and/or curing agents may be added to the concrete forming materials in various ways. For example, in some embodiments, dry ice may be added to the concrete forming materials prior to dispensing the materials from the concrete dispensing assembly. Carbon dioxide and/or carbon dioxide clathrate may also be sprayed onto a surface of the dispensed mixture to accelerate the curing of the mixture.

Further disclosed herein are embodiments wherein a concrete mixture is sprayed from the concrete dispensing assembly in combination with a carbon dioxide clathrate. In doing so, the concrete mixture rapidly cures thereby allowing multiple layers to be readily built up.

These and other aspects of the present disclosure will be discussed in greater detail hereinafter.

### BRIEF DESCRIPTION OF THE DRAWINGS

The embodiments disclosed herein will become more fully apparent from the following description and appended claims, taken in conjunction with the accompanying drawings. These drawings depict only typical embodiments, which will be described with additional specificity and detail through use of the accompanying drawings in which:

FIG. 1 is a perspective view of a construction system, according to an embodiment of the present disclosure.

FIG. 2A is a perspective view of a pattern of discrete units, according to an embodiment of the present disclosure.

FIG. 2B is a perspective view of another pattern of discrete units, according to another embodiment of the present disclosure.

FIG. 3A is a perspective view of a discrete unit, according to another embodiment of the present disclosure.

FIG. 3B is a cross-sectional view of the discrete unit of FIG. 3A.

FIG. 4 is an enlarged view of a portion of a construction system, according to another embodiment of the present disclosure.

FIG. 5 is an enlarged view of a portion of another construction system, according to another embodiment of the present disclosure.

FIG. 6 is a perspective view of a discrete unit, according to another embodiment of the present disclosure.

FIG. 7 is a perspective view of a portion of a construction system that is dispensing a curing agent onto a discrete unit, according to another embodiment of the present disclosure.

FIG. 8 is a perspective view of a discrete unit, according to another embodiment of the present disclosure.

FIG. 9 is a perspective view of another construction system, according to another embodiment of the present disclosure.

FIG. 10A is a perspective view of a pattern of concrete mixtures, according to another embodiment of the present disclosure.

FIG. 10B is an end view of the pattern of concrete mixtures of FIG. 10A.

FIG. 11A is a perspective view of another pattern of concrete mixtures, according to another embodiment of the present disclosure.

FIG. 11B is an end view of the pattern of concrete mixtures of FIG. 11A.

FIG. 12A is a perspective view of another pattern of concrete mixtures, according to another embodiment of the present disclosure.

FIG. 12B is an end view of the pattern of concrete mixtures of FIG. 12A.

FIG. 13 is an enlarged view of a portion of a construction system that is simultaneously dispensing first and second concrete mixtures, according to another embodiment of the present disclosure.

FIG. 14 is an enlarged view of a portion of a construction system that is simultaneously dispensing first, second, and third concrete mixtures, according to another embodiment of the present disclosure.

FIG. 15 is a perspective view of another construction system that is simultaneously dispensing a concrete mixture and a curing agent, according to another embodiment of the present disclosure.

### DETAILED DESCRIPTION

The embodiments disclosed herein relate to construction systems, assemblies, and methods. For example, in various embodiments, the disclosed systems and methods can be used for manufacturing concrete structures. In some embodiments, the disclosed systems and methods comprise a concrete dispensing assembly. The concrete dispensing assembly can be configured to dispense a plurality of discrete units. In other embodiments, the concrete dispensing assembly is configured to simultaneously dispense two or more different concrete mixtures.

The concrete dispensing assemblies can comprise various components. In some embodiments, the concrete dispensing assembly comprises a dispensing head. For example, the dispensing head can be an extrusion head, a pour head, a spray head, or a rotary head. Other types of dispensing heads can also be used.

In some embodiments, the dispensing head is configured to shape or form the mixtures that are being dispensed. The concrete dispensing assemblies can further comprise one or more additional shaping devices. The shaping devices may be coupled to the dispensing head. In some embodiments, the shaping device comprises a removable face plate. In some embodiments, the shaping device comprises one or more trowels.

The disclosed concrete dispensing assemblies can be controllable. In some embodiments, for example, the concrete dispensing assemblies can comprise a computer control system. The computer control system can comprise one or more processors. Further, the computer control system can comprise a user interface.

The concrete dispensing assemblies can further comprise an orientation control mechanism. In some embodiments, the orientation control mechanism is coupled to the computer control system. The orientation control mechanism can be configured to control movement of the concrete dispensing assemblies in three dimensions. For example, the orientation control mechanism may control movement along the X, Y, and Z axes.

Additives and/or curing agents may also be used in the embodiments disclosed herein. In some embodiments, the additives and/or curing agents can comprise carbon dioxide. For example, in some embodiments, the additives and/or curing agents comprise dry ice. In other embodiments, the additives and/or curing agents comprise carbon dioxide clathrate. Curing agents may be used to accelerate the curing rate, or can be used to retard the curing rate. In some embodiments, accelerants can include calcium chloride, calcium formate, calcium nitrite, or calcium thiosulfate, singly or in combination. In some embodiments, retardants may be used to reduce the rate of evaporative water loss. Other additives and/or curing agents can also be used.

The additives and/or curing agents may be added to the concrete forming materials in various ways. For example, in some embodiments, dry ice may be added to the concrete forming materials prior to dispensing the materials from the concrete dispensing assembly. Carbon dioxide and/or carbon dioxide clathrate may also be sprayed onto a surface of the dispensed mixture to accelerate the curing of the mixture.

Further disclosed herein are embodiments wherein a concrete mixture is sprayed from the concrete dispensing assembly in combination with a carbon dioxide clathrate. In doing so, the concrete mixture rapidly cures thereby allowing multiple layers to be readily built up.

The embodiments of the disclosure will be best understood by reference to the drawings, wherein like parts are designated by like numerals throughout. The components of the disclosed embodiments, as generally described and illustrated in the figures herein, could be arranged and designed in a wide variety of different configurations. Furthermore, the features, structures, and operations associated with one embodiment may be applicable to or combined with the features, structures, or operations described in conjunction with another embodiment. In other instances, well-known structures, materials, or operations are not shown or described in detail to avoid obscuring aspects of this disclosure.

Thus, the following detailed description of the embodiments of the systems and methods of the disclosure is not intended to limit the scope of the disclosure, as claimed, but is merely representative of possible embodiments. In addition, the steps of a method do not necessarily need to be executed in any specific order, or even sequentially, nor do the steps need to be executed only once.

As used herein, the phrases “connected to,” “coupled to,” and “in communication with” refer to any form of interaction between two or more entities, including but not limited to mechanical, electrical, magnetic, electromagnetic, fluid, and thermal interaction. Two components may be coupled to each other even though they are not in direct contact with each other. For example, two components may be coupled to each other through an intermediate component.

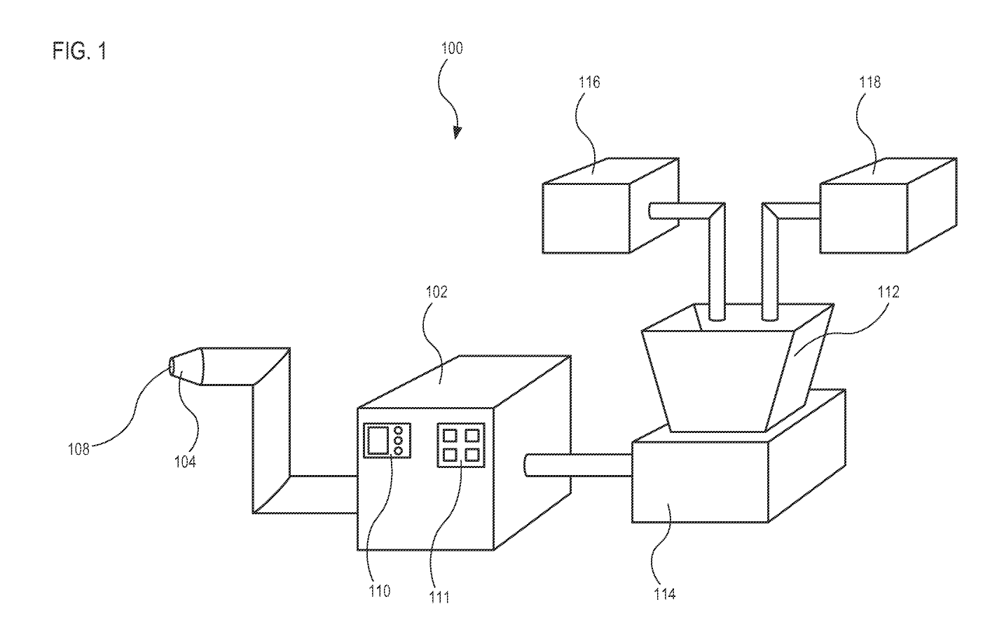

FIG. 1 is a perspective view of a construction system 100, according to an embodiment of the present disclosure. In various embodiments disclosed herein, the construction system 100 can be used in the manufacturing of concrete structures. As detailed below, for example, the system 100 can be configured to dispense one or more concrete forming materials and/or concrete mixtures.

The system 100 may comprise various components. As shown in FIG. 1, for example, the system 100 may comprise a concrete dispensing assembly 102. The concrete dispensing assembly 102 may also be described as a concrete dispensing device. The concrete dispensing assembly 102 can be configured in various ways. In the illustrated embodiment, for example, the concrete dispensing assembly 102 is configured to dispense a plurality of discrete units. In other words, rather than dispensing a continuous flow of material, the concrete dispensing assembly 102 is configured to dispense a plurality of individual discrete units of material. For example, the concrete dispensing assembly 102 can be configured to dispense a plurality of individual discrete units in succession (i.e., in series, or one after another). Further, the concrete dispensing assembly 102 can also be configured to dispense a plurality of individual discrete units simultaneously. For example, the concrete dispensing assembly 102 may be configured to dump or spew a plurality of discrete units at the same time. In these embodiments wherein the concrete dispensing assembly 102 is configured to dispense discrete units, the concrete dispensing assembly 102 may be described as a digital concrete dispensing assembly 102. In other embodiments, which are detailed below, the concrete dispensing assembly 102 is configured to dispense one or more continuous flows of material.

Dispensing digital or discrete units is advantageous in various construction applications. For example, in some embodiments, a user may determine a specified number of discrete units that may be needed to form a particular concrete structure. The user may thereafter dispense the specified number of discrete units. The discrete units can then be arranged or positioned as desired. For example, the user may stack the discrete units to build a wall-type structure. In other embodiments, the plurality of discrete units may be dispensed in a specified sequence or pattern such that the user need not rearrange or reposition them. This pattern may be predetermined. Further, the pattern may be controlled by the user. In some embodiments, the pattern may be programmed into the concrete dispensing assembly 102. For example, the pattern may be programmed into a computer control system 110 that is coupled to or integral with the concrete dispensing assembly 102.

In some embodiments, the number of discrete units that are dispensed is predetermined. For example, the concrete dispensing assembly 102 may be set or otherwise configured to dispense a predetermined number of discrete units. In other embodiments, the number of discrete units that are dispensed is determined and controlled by the user during the dispensing process. For example, one or more concrete forming materials may be fed into the concrete dispensing assembly 102 and the user may continuously dispense discrete units until a desired number has been dispensed.

Further, in some embodiments, the number of discrete units being dispensed from the concrete dispensing assembly 102 is counted. The number can be counted manually by the user, or counted automatically by the concrete dispensing assembly 102. For example, the concrete dispensing assembly 102 may comprise a computer control system 110 that may be configured to automatically count the number of discrete units that are dispensed.

Counting the number of discrete units that have been, or are being, dispensed may be useful for tracking and/or monitoring purposes. For example, counting the number of discrete units that have been dispensed may be useful in determining the volume of material that has been dispensed. Counting the number of discrete units that have been dispensed may also be useful in controlling one or more aspects of the dispensing process. For example, in some embodiments, the concrete dispensing assembly 102 is configured to dispense a first plurality of discrete units and a second plurality of discrete units. The value of one or more parameters of the first plurality of discrete units and the second plurality of discrete units may be different. Such parameters include the composition, size, shape, curing rate, tensile strength, compressive strength, water content, cement content, concrete aggregate content, additive content, etc.

As can be appreciated, it may be desirous to dispense a specified first number of discrete units of the first plurality and a specified second number of discrete units of the second plurality. By separately counting and tracking the number of discrete units of the first and second pluralities that are dispensed, the user may ensure that the proper amounts of discrete units are dispensed. For example, during the dispensing process, the number of discrete units of the first plurality that are dispensed may be counted separately from the number of discrete units of the second plurality that are dispensed. Once the proper amounts of the first and second pluralities of discrete units have been dispensed, the concrete dispensing assembly may be configured to stop the dispensing process.

For illustration purposes, a more specific example may include the following: A particular construction application may require 15 large discrete units and 25 small discrete units. The 15 large discrete units may be representative of a first number of discrete units of a first plurality having a particular parameter (large size). The 25 small discrete units may be representative of a second number of discrete units of a second plurality having a particular parameter (small size). During the dispensing process, the concrete dispensing assembly may separately count the number of large and small discrete units that are dispensed. After the desired number of large and small discrete units have been dispensed, the concrete dispensing assembly may stop the dispensing process. Accordingly, by counting and/or tracking the number of discrete units that are dispensed, the user may ensure that the proper amounts of discrete units are dispensed thereby eliminating and/or reducing the amount of waste that is produced.

The composition of the discrete units may vary as desired. In some embodiments, the discrete units comprise one or more concrete forming materials, including, but not limited to, cement, concrete aggregate, and water. For example, the discrete units may comprise a mixture of cement, concrete aggregate, and water. Such mixtures comprising cement, concrete aggregate, and water may be referred to as “concrete mixtures.” As can be appreciated, the relative amount of cement, concrete aggregate, and/or water may be varied to achieve desired properties and/or characteristics.

In many embodiments, the discrete units that are dispensed comprise un-cured mixtures of one or more concrete forming materials. However, whether the discrete units comprise un-cured mixtures or cured mixtures may vary depending on the particular construction application. As such, in other embodiments, the discrete units can comprise cured mixtures of concrete forming materials. Still further, the discrete units can comprise partially cured mixtures of concrete forming materials.

In further embodiments, the discrete units may comprise mixtures that are dehydrated and/or substantially dry. For example, the discrete units may comprise a substantially dry mixture of cement and/or concrete aggregate. At the discretion of the user, one or more discrete amounts of water may thereafter be dispensed, either from the concrete dispensing assembly or from another water dispensing device (e.g., a hose, water truck, etc.). At the further discretion of the user, the one or more discrete amounts of water may be mixed with the dry discrete units and allowed to dry to form a concrete structure.

The composition of the discrete units may further comprise one or more additives. Various additives may be used, including, but not limited to, one or more of the following: water (or water agents), curing agents, colorants, strengthening agents, and reinforcing agents. Other additives known in the art or hereinafter developed may also be used. As can be appreciated, the additives may be configured to provide the discrete units with one or more desired properties and/or characteristics at the user's discretion.

The composition between different discrete units may also be variable. In other words, the composition of a first discrete unit may vary from the composition of a second discrete unit. For example, the amount of cement, concrete aggregate, and/or water may vary between different discrete units depending on the desired application. Other properties and/or parameters of the discrete units may also be varied. For example, the size, shape, tensile strength, compressive strength, water content, etc. may vary between different discrete units as desired.

Further, in some embodiments, the user may control, adjust, and/or change the composition of the discrete units during the dispensing process. For example, the user may increase or decrease the amount of any particular component of the discrete units. For example, a user may increase or decrease the relative amount of cement, concrete aggregate, and/or water that may be used to form the discrete units. In some embodiments, the composition of the discrete units may be controlled by a computer control system 110.

It is contemplated that the discrete units may be dispensed from the concrete dispensing assembly 102 in various ways. In some embodiments, for example, the discrete units may be extruded from the concrete dispensing assembly 102. In other embodiments, the discrete units may be dumped from the concrete dispensing assembly 102. In yet other embodiments, the discrete units may be spewed or otherwise ejected from the concrete dispensing assembly 102.

In some embodiments, the concrete dispensing assembly 102 is configured to cover each discrete unit, or at least a portion of each discrete unit, with a covering or covering material. For example, the covering may comprise a skin-like material. In some embodiments, the concrete dispensing assembly 102 is configured to cover the discrete unit during the dispensing process (i.e., while the discrete unit is being dispensed). In other embodiments, the concrete dispensing assembly 102 is configured to cover the discrete unit prior to dispensing the discrete unit.

Covering the discrete units may yield various benefits and/or advantages. For example, in some embodiments, the covering may be configured to retain the contents of the discrete unit. In embodiments wherein the discrete unit comprises substantially dry cement and concrete aggregate, for example, the covering may retain or otherwise hold the mixture together. Further, in some embodiments, the covering may be used to retain the discrete unit in a designated shape.

The covering may also be used as an indicator. For example, in some embodiments, the covering comprises a colorant. The color of the covering may also depend on a parameter of the discrete unit. And different colors and/or colorants may represent different characteristics of the discrete units. For example, in an illustrative embodiment, a blue colorant may indicate that the discrete unit comprises a first composition, and a red colorant may indicate that the discrete unit comprises a second composition.

The covering may comprise various types of materials. For example, in some embodiments, the covering comprises a gelling compound. In other embodiments, the covering comprises a layer comprising carbon dioxide. In other embodiments, the covering comprises a film or film-like material. In other embodiments, the covering comprises a woven material. The woven material may comprise polymeric and/or metallic materials. In some embodiments, the woven material comprises a mesh material.

Other properties of the covering may also vary as desired. In some embodiments, for example the covering comprises a substantially water soluble material. The substantially water soluble material may be configured to substantially dissolve when contacted (e.g., sprayed) with water. In other embodiments, the covering comprises a substantially water penetrable or water permeable material. The substantially water penetrable material may allow water to pass. The substantially water penetrable material may or may not be dissolvable. In yet other embodiments, the covering comprises a substantially water insoluble material. In yet other embodiments, the covering comprises a substantially water impenetrable or water impermeable material.

With continued reference to FIG. 1, in certain embodiments, one or more aspects of the concrete dispensing assembly 102 may be controllable. For example, a user may control one or more dispensing parameters of the concrete dispensing assembly 102. The controllable dispensing parameters include the dispensing rate, and the dispensing volume (e.g., the number of discrete units). In some embodiments, the dispensing parameter is controllable in response to the number of discrete units that have been dispensed. For example, in some embodiments, once a specified number of discrete units have been dispensed, the concrete dispensing assembly may be configured to stop the dispensing process. The dispensing parameter can also be controllable in response to a sensor measurement. For example, a sensor measurement may include a sensor measurement of temperature, moisture, flow rate, size, shape, load, etc. In some embodiments, the sensors may be imaging devices, providing measurements of the spatial distribution of the dispensed concrete, additives and/or reinforcements. In other embodiments, imaging sensors may provide information on the spatial distribution of concrete properties such as temperature, moisture, etc.

The concrete dispensing assembly 102 may be controlled in various ways. For example, in some embodiments, the concrete dispensing assembly 102 is manually controlled. In other embodiments, the concrete dispensing assembly 102 is controlled by a computer control system 110. In yet other embodiments, one or more dispensing parameters of the dispensing assembly 102 are controlled manually, and one or more dispensing parameters of the concrete dispensing assembly 102 are controlled by a computer control system 110.

Various types of computer control systems 110 may be used. In some embodiments, the computer control system 110 is integral with the concrete dispensing assembly 102. In other embodiments, the computer control system 110 is coupled to the concrete dispensing assembly 102. Further, the computer control system 110 may be coupled to the concrete dispensing assembly 102 via a wired or a wireless connection network.

The computer control system 110 comprises various components. In some embodiments, the computer control system 110 comprises a control interface. Through the control interface, the user may interact with the computer control system 110 to control one or more aspects of the concrete dispensing assembly 102. The computer control system 110 may further comprise one or more processors. The processors may be used to carry out the various input/output operations of the computer control system 110. Any suitable variety of processors may be used. The computer control system 110 may further comprise additional components known in the art or hereinafter developed for use in computer control systems 110.

As further shown in FIG. 1, in some embodiments, the system 100 further comprises an orientation control mechanism 111. The orientation control mechanism 111 may be integral with the concrete dispensing assembly 102. In other embodiments, the orientation control mechanism 111 is coupled to the concrete dispensing assembly 102. Further, in some embodiments, the orientation control mechanism 111 may be coupled to, and controlled by, the computer control system 110.

The orientation control mechanism 111 may be manually, mechanically, and/or electrically controllable. Further, the orientation control mechanism 111 may be configured to control the orientation of the concrete dispensing assembly 102 in at least three different dimensions. For example, the orientation control mechanism 111 may be configured to control the orientation of the concrete dispensing assembly 102 along an X-axis, Y-axis, and/or Z-axis.

With continued reference to FIG. 1, in some embodiments, the concrete dispensing assembly 102 comprises a dispensing head 104. More specifically, a dispensing head 104 may be coupled to the concrete dispensing assembly 102, or a dispensing head 104 may be integral with the concrete dispensing assembly 102. Various types of dispensing heads may be used. For example, the dispensing head 104 may comprise an extrusion head, a pellet conveyer, a spray head, or a rotary dispenser. Other types of dispensing heads 104 commonly known or hereinafter developed may also be used.

The concrete dispensing assembly 102 may further comprise one or more openings or orifices 108. The orifice 108 may be disposed on the dispensing head 104. The size and/or shape of the orifice 108 may determine the size and/or shape of the discrete units. In other words, the size and/or shape of the discrete units may be dependent upon the size and/or shape of the orifice 108. For example, the discrete units may be dispensed from the concrete dispensing assembly 102 through the orifice 108. Further, in some embodiments, the discrete units are extruded through the orifice 108. As can be appreciated, as the discrete units are dispensed through the orifice 108, the discrete units may be shaped and/or sized in accordance with the shape and/or size of the orifice 108.

The shape and/or size of the orifice 108 may vary. For example, in some embodiments the orifice 108 is substantially rectangular in shape. In yet other embodiments, the orifice 108 is substantially square in shape. In still other embodiments, the orifice 108 is substantially circular in shape. In still other embodiments, the orifice 108 is substantially oval in shape. Other shapes are also contemplated. Further, in some embodiments, the shape and/or size of the orifice 108 is changeable.

Other types of shaping devices or shaping tools may also be used. For example, in some embodiments a face plate may be coupled to the concrete dispensing assembly 102. The face plate may also be coupled to the dispensing head 104 of the concrete dispensing assembly 102. The face plate may be removable. The orifice 108 may also extend through the face plate. In some embodiments, the face plate may be used to alter or change the shape of the orifice 108 thereby shaping the discrete units that are being dispensed from the concrete dispensing assembly 102. Other shaping devices that may also be used include trowels. Trowels may be coupled to the concrete dispensing assembly 102, or coupled to the dispensing head 104 of the concrete dispensing assembly 102, and may aid in shaping the discrete units.

As further shown in FIG. 1, in some embodiments, the system 100 further comprises one or more hoppers 112. The hoppers 112 may be configured temporarily to retain, stir, and/or mix the various concrete forming materials that are used to form the discrete units. For example, one or more concrete forming materials may be fed into the hopper 112. As shown in FIG. 1, in some embodiments, the concrete forming materials may be fed into the hopper 112 from a feeding device 118. The concrete forming materials may thereafter be delivered from the hopper 112 to the concrete dispensing assembly 102. In the illustrated embodiment, the concrete dispensing assembly 112 is then configured to dispense the concrete forming materials as discrete units.

As shown in the illustrated embodiment, the hopper 112 may be coupled to the concrete dispensing assembly 102. The hopper 112 is also in fluid communication with the dispensing head 104 and the orifice 108 through which the concrete forming materials are dispensed. Accordingly, the one or more concrete forming materials may be transferred or otherwise passed from the hopper 112 to the concrete dispensing assembly 102 and out of the orifice 108 during a typical dispensing process.

One or more intermediate components may also be used with the disclosed system 100. Exemplary intermediate components include pumps, conveyors, extrusion screws, tubes, and/or other devices that may be configured to retain, transfer, mix, and/or move the one or more concrete forming materials throughout the system 100.

As previously stated, in some embodiments, one or more additives may be used. In some embodiments, the additives are mixed with the concrete forming materials that are used in forming the plurality of discrete units. For example, the additives may be mixed with the concrete forming materials prior to dispensing the discrete units from the concrete dispensing assembly. Further, in some embodiments, the additives are mixed with the concrete forming materials in a hopper 112. In other embodiments, the additives are applied to the discrete units during the dispensing process, or after the discrete units have been dispensed.

As shown in the illustrated embodiment of FIG. 1, the system 100 may comprise an additive dispensing device 116. The additive dispensing device 116 may be configured to dispense the additives into the hopper 112 wherein the additives may be mixed with the concrete forming materials. In other embodiments, the additives may be added without the use of an additive dispensing device 116. For example, a user may merely add additives by emptying the contents of a bag or other container containing the additive into the hopper 112.

In some embodiments, the concrete dispensing assembly 102 can be configured to dispense additives. For example, the concrete dispensing assembly 102 can be configured to dispense the additives into the discrete units or onto at least one surface of the discrete units. Further, in some embodiments, the additives are dispensed by the concrete dispensing assembly 102 during the dispensing process.

In certain embodiments, the additives may be sprayed on the discrete units. The additives may be sprayed on the discrete units either while the discrete units are being dispensed, or after the discrete units have been dispensed. Further, the additives may be sprayed on the entirety of the discrete units, or on only a portion of the discrete units. For example, the additives may be sprayed on at least one outer surface of the discrete units. The additives may also be sprayed onto at least a corner of the discrete units.

Various types of additives may be used. In some embodiments, the additive comprises water. Further, in some embodiments, the additive is mixed with water. For example, an additive may be mixed with water to form an aqueous additive mixture. A discrete amount of the aqueous additive mixture may thereafter be dispensed to the discrete unit.

In some embodiments, the additive comprises a curing agent. The curing agent can be configured to accelerate the curing of the concrete forming materials. When applied to a surface of a discrete unit, the curing agent may be configured to accelerate the curing of at least the surface (or portion) of the discrete unit to which it has been applied. Exemplary curing agents may comprise carbon dioxide. For example, in some embodiments, the curing agent may comprise carbon dioxide, carbon dioxide clathrate, and/or dry ice. In other embodiments, the additive may comprise a curing inhibitor that may be configured to delay the curing of the concrete forming materials. Other types of additives may also be used.

When using dry ice as an additive and/or curing agent, the dry ice may be configured to sublime and disperse carbon dioxide throughout a portion of at least one discrete unit. In doing so, the curing rate is accelerated throughout the portion of the discrete unit comprising the dry ice. If desired, the dry ice may comprise a temporary outer barrier (e.g., a shell or coating) that is configured to delay sublimation of the dry ice.

Additionally, in some embodiments, the additives may be configured to control the curing rate of the concrete forming materials. Such additives may be described as rate controlling additives. Exemplary rate controlling additives comprise cement powder. The rate controlling additives may be applied in various ways. For example, in some embodiments, the rate controlling additives are dispensed and mixed with the concrete forming materials prior to dispensing the discrete units. In other embodiments, the rate controlling additives are dispensed during the dispensing process. In yet other embodiments, the rate controlling additives are dispensed onto a surface of the discrete units after they have been dispensed.

The rate control additives comprising cement powder may further be mixed with a fluidizing agent. The fluidizing agent may be configured to aid in the transportation and dispersion of the cement powder. In some embodiments, the fluidizing agent comprises ethylene glycol. Other types of fluidizing agents may also be used.

In further embodiments, the additive comprises one or more reinforcement members. The reinforcement members may be configured to add strength and support to the discrete units. Various types of reinforcement members may be used. For example, in some embodiments, the reinforcement member comprises rebar. In other embodiments, the reinforcement member comprises mesh. The mesh may include a metal material (e.g., steel), and/or a polymeric material. In some embodiments, the reinforcement member comprises a fiber or fiber-like material, such as, for example, fiberglass, metallic fiber (steel fiber), and/or synthetic fiber.

The reinforcement member may be dispensed in various ways. For example, in some embodiments, the reinforcement member is dispensed into at least one of the discrete units while the discrete unit is being dispensed from the concrete dispensing assembly 102. In other embodiments, the reinforcement member may be dispensed into at least one of the discrete units after the discrete unit has been dispensed from the concrete dispensing assembly 102.

In some embodiments, the reinforcement member is dispensed such that it is at least partially disposed in at least one discrete unit. The reinforcement member may also be dispensed such that it is entirely disposed within a discrete unit. Further, in some embodiments, the reinforcement member is dispensed such that it is at least partially disposed within a first discrete unit and at least partially disposed within a second discrete unit. In other embodiments, the reinforcement member is dispensed such that it is adjacent to at least one discrete unit. For example, the reinforcement member may be dispensed such that it is disposed between two discrete units.

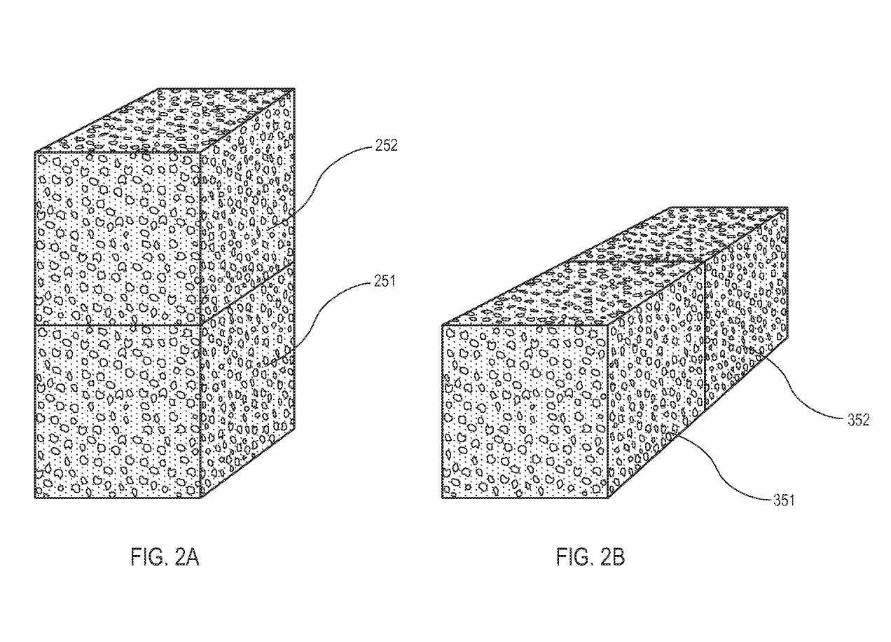

As previously stated, the plurality of discrete units may be dispensed in a predetermined pattern. Exemplary patterns are depicted in FIGS. 2A-2B. These patterns are intended to be illustrative in nature and not exhaustive. Indeed, patterns other than those depicted in FIGS. 2A-2B are also contemplated. In FIG. 2A, the discrete units 251, 252 have been dispensed such that they are stacked vertically. More specifically, a first discrete unit 251 is disposed on the bottom and a second discrete unit 252 is disposed such that it is stacked on top of the first discrete unit 251. Accordingly, in some patterns, two or more discrete units 251, 252 are stacked on top of one another. The illustrated discrete units 251, 252 may also be described as being disposed adjacent to one another along a vertical plane.

In FIG. 2B, the discrete units 351, 352 have been dispensed such that they are adjacent to one another along a horizontal plane. More specifically, a second discrete unit 352 has been dispensed such that it is adjacent to the first discrete unit 351 along a horizontal plane. Further, in the illustrated embodiment, at least one surface of the second discrete unit 352 abuts at least one surface of the first discrete unit 351.

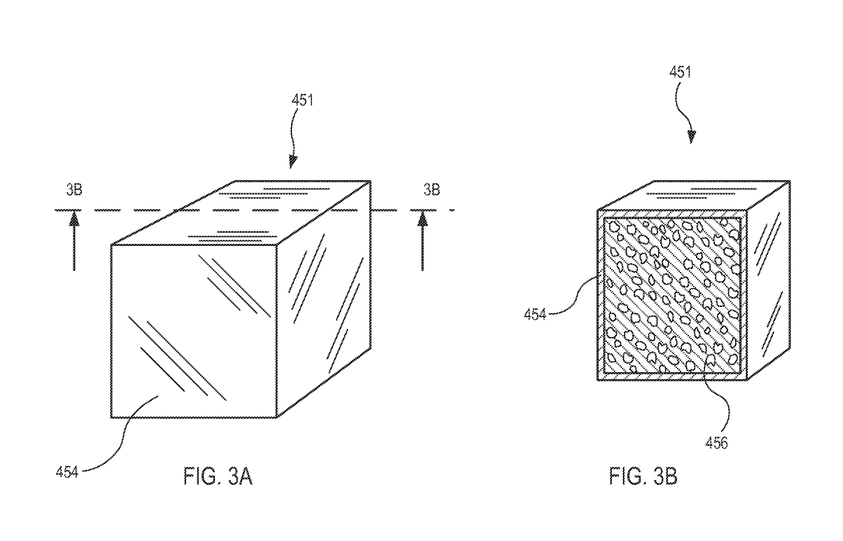

FIGS. 3A-3B are perspective views of a discrete unit 451, according to another embodiment of the present disclosure. As shown in FIGS. 3A-3B, in some embodiments, the discrete unit 451 is covered by the concrete dispensing assembly. For example, in the illustrated embodiment, the discrete unit 451 is covered with a skin-like material 454. Further, in the illustrated embodiment, the discrete unit 451 is encased, or substantially covered, with the skin-like material. In other embodiments, only a portion of the discrete unit 451 is covered by the skin-like material.

In FIG. 3B, a cross-sectional view of the discrete unit 451 is shown. More specifically, FIG. 3B is a cross-sectional view of the discrete unit 451 taken along the view line 3B of FIG. 3A. As shown in FIG. 3B, the interior of the discrete unit comprises a mixture 456 of one or more concrete forming materials. As further shown in FIG. 3B, the skin-like material 454 extends around the discrete unit 451 such that it may retain the mixture 456. For example, the skin-like material 454 may retain the mixture 456 in a designated shape.

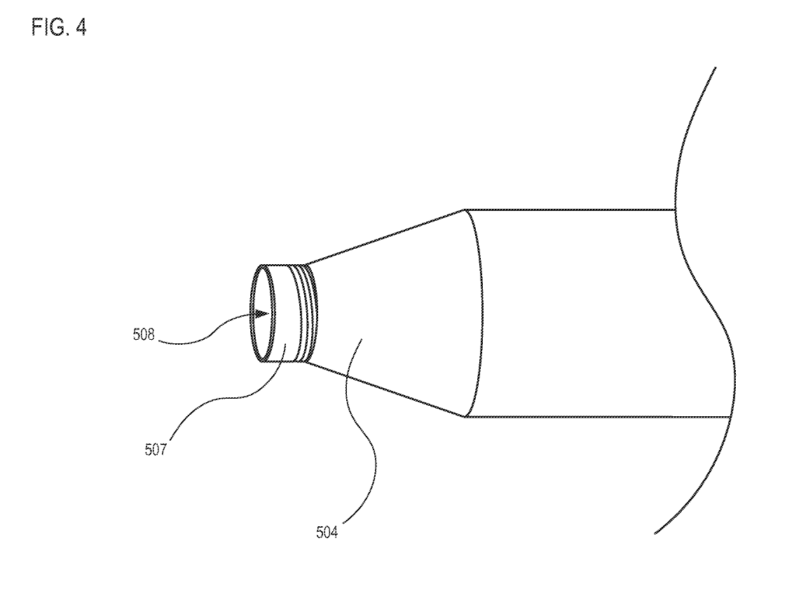

In FIG. 4, an enlarged perspective view of a dispensing head 504 is depicted, according to another embodiment of the present disclosure. As shown in FIG. 4, the dispensing head 504 comprises an orifice 508 through which the plurality of discrete units may be dispensed. In the illustrated embodiment, the dispensing head 504 further comprises a face plate 507. The face plate 507 may be removable, as is indicated by the threaded section of the face plate 507. As previously stated, the face plate 507 may be configured to shape the discrete unit that is being dispensed by the concrete dispensing assembly.

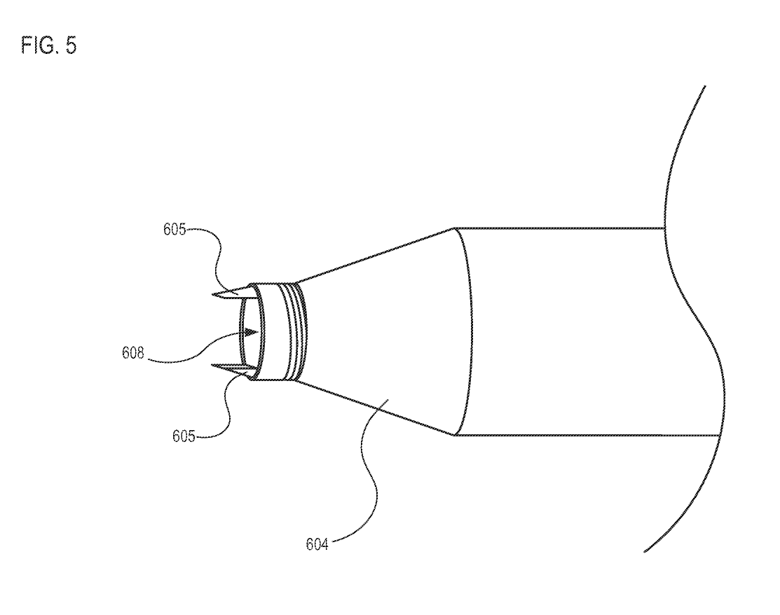

In FIG. 5, an enlarged perspective view of a dispensing head 604 is depicted, according to another embodiment of the present disclosure. As shown in FIG. 5, the dispensing head 604 comprises additional shaping devices 605. In the illustrated embodiments, the shaping devices 605 comprise trowels. As previously stated, the trowels 605 may be configured to shape to the discrete unit being dispensed through the orifice 608.

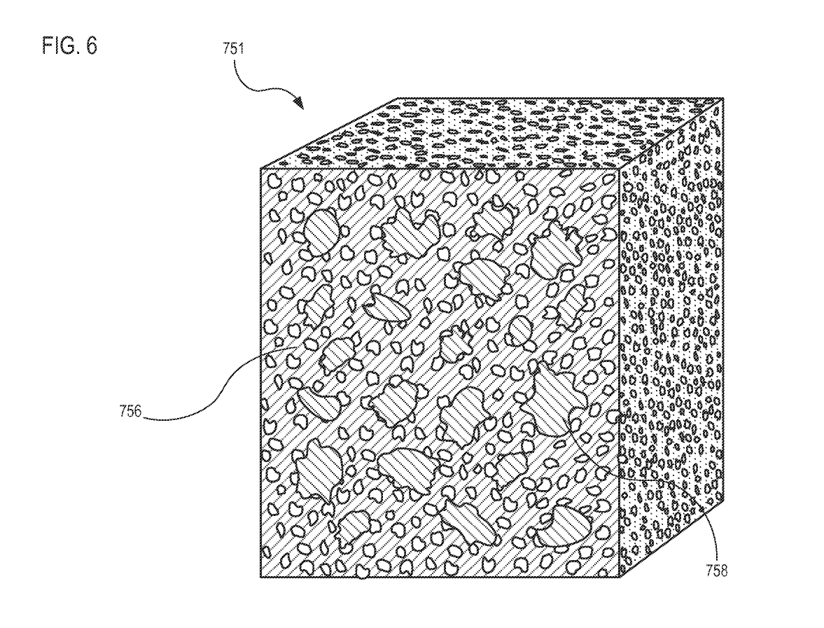

FIG. 6 is a cross-sectional view of a discrete unit 751, according to another embodiment of the present disclosure. In FIG. 6, the discrete unit 751 comprises a mixture 756 of one or more concrete forming materials. Further, the discrete unit 751 comprises dry ice 758. The dry ice 758 may accelerate the curing of at least a portion of the discrete unit 751. More specifically, the dry ice 758 may be configured to sublime and disperse carbon dioxide throughout at least a portion of the discrete unit 751 thereby accelerating the curing of the portion of the discrete unit 751.

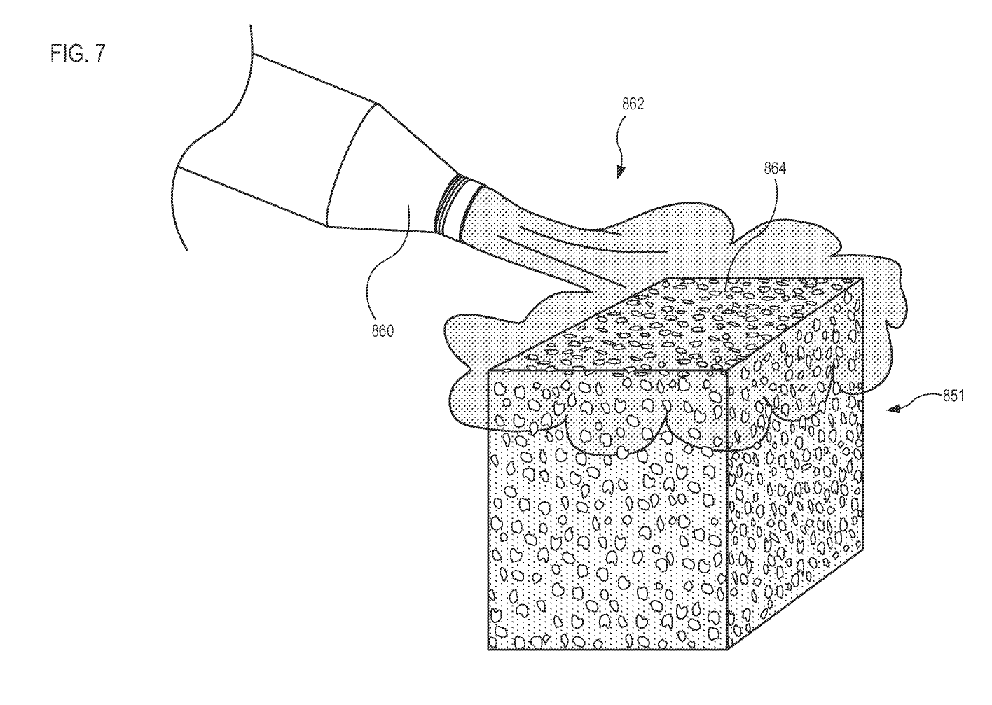

FIG. 7 is a perspective view of a portion of a construction system that is dispensing a curing agent 862 onto a discrete unit 851, according to another embodiment of the present disclosure. As shown in FIG. 7, the curing agent 862 is being sprayed onto at least a portion of the discrete unit 851. More specifically, the curing agent 862 is being sprayed onto an outer surface 864 of the discrete unit 851. In some embodiments, the curing agent 862 is sprayed onto at least a corner of the discrete unit 851. In some embodiments, at least a portion of the discrete unit is optionally not sprayed with the curing agent. As can be appreciated, the curing agent 862 may comprise an additive that is configured to accelerate the curing of at least a portion of the discrete unit 851.

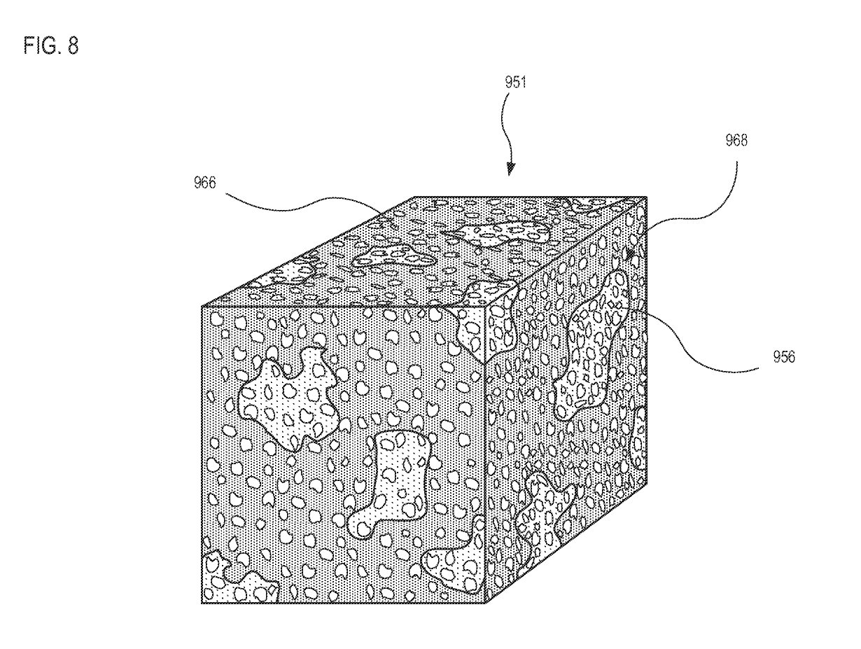

FIG. 8 is a perspective view of a discrete unit 951, according to another embodiment of the present disclosure. In FIG. 8, a curing agent has been sprayed onto the discrete unit 951 such that a portion of the discrete unit 951 has cured or at least partially cured. Further, a portion of the discrete unit 951 has cured to form a shell 966 that extends around at least a portion of the discrete unit 951. The shell 966 does not, however, extend around the entirety of the discrete unit 951. Rather, the shell 966 comprises one or more openings 968. The openings 968 may be advantageous in curing the remainder of the discrete unit 951. For example, the one or more concrete forming materials 956 that are used to form the discrete unit 951 are exposed through the openings 968, which may allow optimal curing of the inside of the discrete unit 951.

Rapidly curing the shell 966 around the discrete unit 951 is advantageous in various construction applications. For example, the shell 966 may be relatively rigid. The shell 966 may also enable the discrete unit 951 to retain its shape. The shell 966 may further enable the discrete unit 951 to be capable of supporting the weight of a material that is placed on top of the discrete unit 951. In other words, one or more materials (e.g., additional discrete units 951) may be stacked on top of the discrete unit 951 after the shell 966 has been formed. Other advantages may also be appreciated.

As previously discussed, various curing agents may be used in accordance with the embodiments disclosed herein. Exemplary curing agents that may be used in curing or partially curing the discrete unit to form the outer shell 966 include curing agents that comprise carbon dioxide or carbon dioxide clathrate. Other curing agents may also be used.

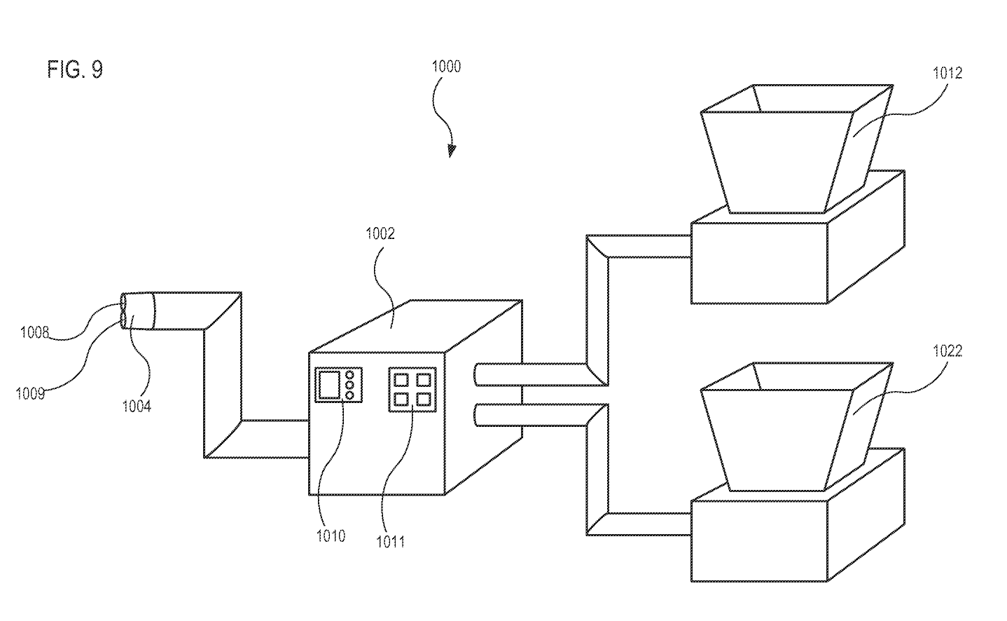

FIG. 9 is a perspective view of another construction system 1000 for manufacturing a concrete structure, according to another embodiment of the present disclosure. Many of the components of the system 1000 are analogous to the components of the system 100 described above in FIG. 1. For example, the system 1000 comprises a concrete dispensing assembly 1002. The concrete dispensing assembly 1002 comprises a computer control system 1010 and an orientation control mechanism 1011. The concrete dispensing assembly 1002 further comprises a dispensing head 1004. The concrete dispensing assembly 1002 further comprises orifices 1008, 1009 and is coupled to hoppers 1012, 1022. Accordingly, the disclosure set forth above with respect to FIGS. 1-8 is largely applicable to the system 1000 of FIG. 9.

The primary difference between the system 1000 of FIG. 9 and the system 100 of FIG. 1 is that in the system 1000 of FIG. 9, the concrete dispensing assembly 1002 is configured to dispense a plurality of concrete mixtures simultaneously. In other words, the concrete dispensing assembly 1002 is configured to dispense a first concrete mixture to form a first concrete layer and a second concrete mixture to form a second concrete layer at the same time. Accordingly, it will be appreciated that the disclosure set forth above is applicable to the dispensing of first and second concrete mixtures, and not limited to the dispensing of discrete units.

Simultaneously dispensing a plurality of concrete mixtures is advantageous in many ways. For example, in some instances, the plurality of concrete mixtures may integrate with one another better when they are dispensed simultaneously. The plurality of concrete mixtures may also cure better when they are dispensed simultaneously. Other advantages may also be realized.

Additionally, in some embodiments, at least one parameter of the first and second concrete mixtures may be different. Simultaneously dispensing the different concrete mixtures may thereby enable the user to design and develop numerous different types of concrete structures having varying properties. For example, in one embodiment, the first concrete mixture has a faster curing rate than the second concrete mixture. In another embodiment, the first concrete mixture has a greater tensile strength than the second concrete mixture. In yet another embodiment, the first concrete mixture has a greater compressive strength than the second concrete mixture. In yet another embodiment, the first concrete mixture has a greater water content than the second concrete mixture. In yet another embodiment, the first concrete mixture has a greater cement content than the second concrete mixture. In yet another embodiment, the first concrete mixture has a different cement composition from the second concrete mixture. In yet another embodiment, the first concrete mixture has a different concrete aggregate content from the second concrete mixture. Other properties may also be varied.

With continued reference to FIG. 9, in the illustrated embodiment the concrete dispensing assembly comprises a first orifice 1008 and a second orifice 1009. As can be appreciated, the first concrete mixture may be dispensed through the first orifice 1008 and the second concrete mixture may be dispensed through the second orifice 1009. Further, in certain embodiments, the first concrete mixture is extruded through the first orifice 1008 and the second concrete mixture is extruded through the second orifice 1009. In some embodiments, the first orifice 1008 abuts the second orifice 109, while in other embodiments they may be physically separated.

The shape of the first and second orifices 1008, 1009 may be the same as that described above with respect to the orifice 108 of FIG. 1. Additionally, the shape of the first and second orifices 1008, 1009 may be substantially the same, or the shape of the first and second orifices may be different.

As further shown in FIG. 9, the illustrated system 1000 comprises a first hopper 1012 and a second hopper 1022. The hoppers 1012, 1022 are analogous to the hopper 112 described above with respect to FIG. 1. In FIG. 9, however, the first hopper 1012 is configured to temporarily retain and/or mix the first concrete mixture and the second hopper 1022 is configured to temporarily retain and/or mix the second concrete mixture. Additionally, the first hopper 1012 is in fluid communication with the first orifice 1008 and the second hopper 1022 is in fluid communication with the second orifice 1009.

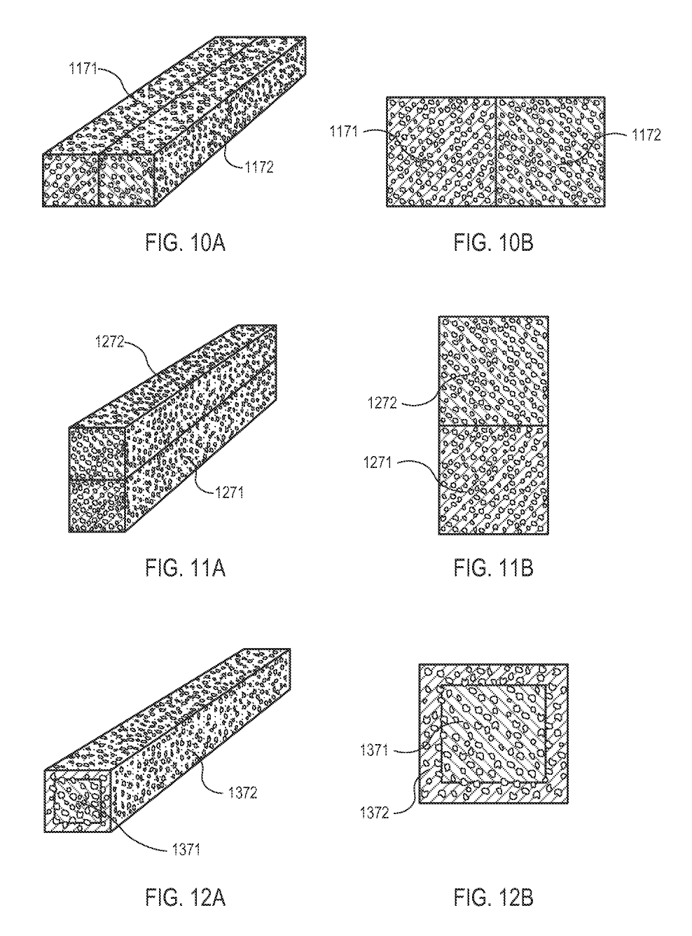

As can be appreciated, the first and second concrete mixtures may be dispensed by the system 1000 to form a predetermined pattern of concrete layers. For example, FIGS. 10A-10B, 11A-11B, and 12A-12B depict exemplary patterns of simultaneously dispensed concrete mixtures 1171, 1172, 1271, 1272, 1371, 1372, according to various embodiments of the present disclosure. In FIGS. 10A-10B, the first concrete mixture 1171 and the second concrete mixture 1172 are dispensed to form concrete layers that are disposed adjacent to one another along a horizontal plane. The first and second concrete mixtures 1171, 1172 may be described as being co-planar along a horizontal plane.

In FIGS. 11A-11B, the first concrete mixture 1271 and the second concrete mixture 1272 are dispensed to form concrete layers wherein the first concrete mixture 1271 is disposed directly on top of the second concrete mixture 1272. In other words, the first concrete mixture 1271 and the second concrete mixture 1272 may be described as being co-planar along a vertical plane.

In FIGS. 12A-12B, the first concrete mixture 1371 is disposed such that it is encased or otherwise surrounded by the second concrete mixture 1372. Other patterns are also contemplated. Further, in each of FIGS. 10A-10B, 11A-11B, and 12A-12B, the concrete mixtures 1171, 1172, 1271, 1272, 1371, 1372 are dispensed such that at least one surface of a first concrete mixture 1171, 1271, 1371 abuts at least one surface of a second concrete mixture 1172, 1272, 1372. In other embodiments, one or more intermediate materials may be dispensed between the first and second concrete mixtures.

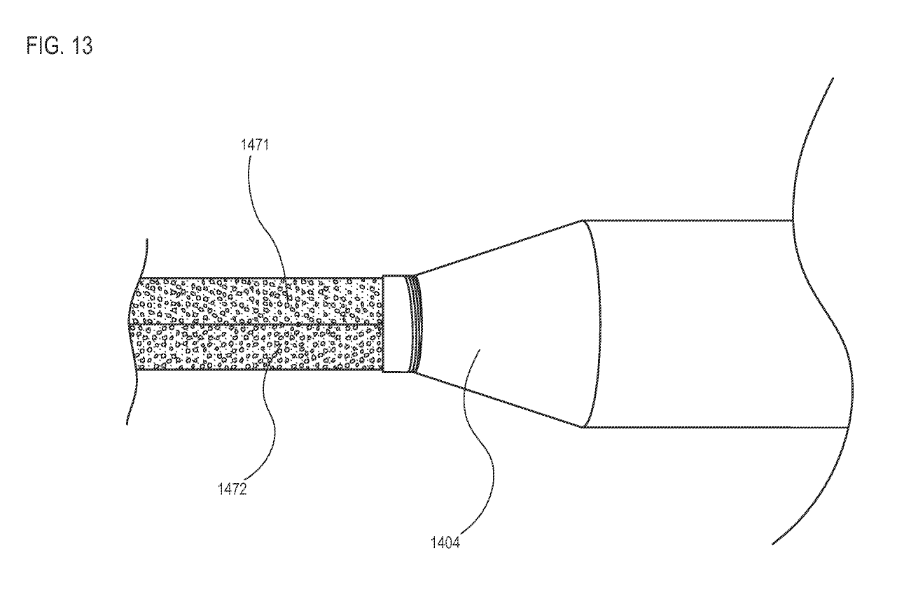

In FIG. 13, an enlarged view of a portion of a construction system is depicted as it is simultaneously dispensing first and second concrete mixtures 1471, 1472, according to another embodiment of the present disclosure. As shown in FIG. 13, in some embodiments, the first and second concrete mixtures 1471, 1472 may be extruded from a dispensing head 1404. Further, the first and second concrete mixtures 1471, 1472 are dispensed such that they abut one another and are in direct contact with one another along one side of each of the first and second concrete mixtures 1471, 1472.

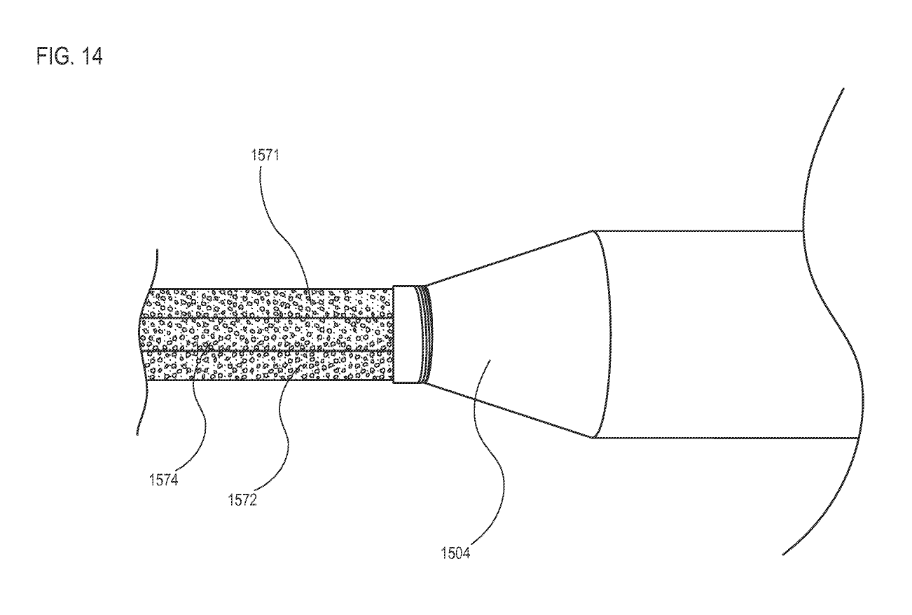

FIG. 14 is an enlarged view of a portion of a construction system that is simultaneously dispensing first and second concrete mixtures 1571, 1572, according to another embodiment of the present disclosure. As shown in FIG. 14, in some embodiments, the first and second concrete mixtures 1571, 1572 may be extruded from a dispensing head 1504. Further, an intermediate layer 1574 may be extruded or otherwise dispensed such that it is disposed between the first and second concrete mixtures 1571, 1572. In some embodiments, the intermediate layer 1574 comprises a third concrete mixture. In other embodiments, the intermediate layer 1574 comprises a non-concrete material, such as a curing agent, a reinforcement, a separator, a material to improve adherence between mixtures 1571 and 1572, etc.

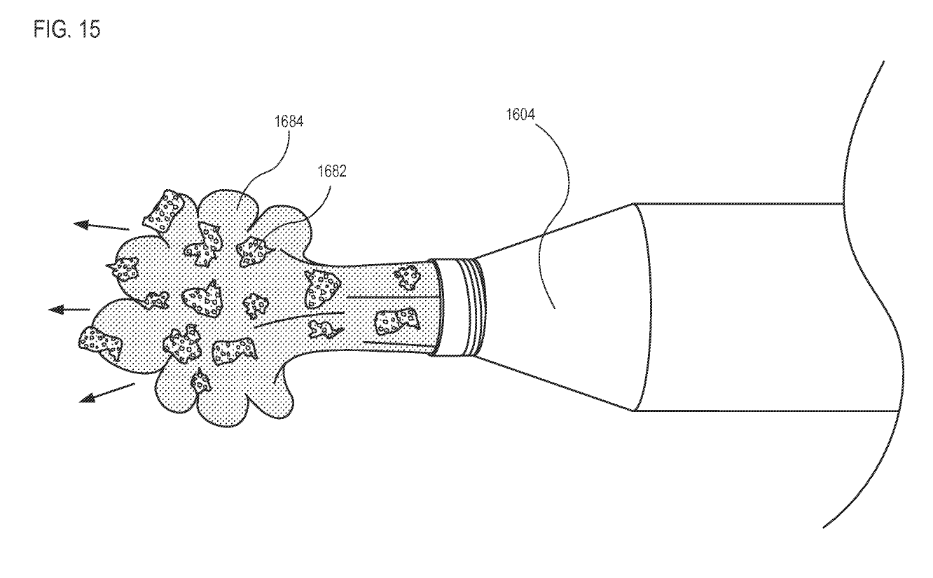

FIG. 15 is a perspective view of another construction system, according to another embodiment of the present disclosure. As shown in FIG. 15, in some embodiments, the system may simultaneously dispense a concrete mixture 1682 and a curing agent 1684. For example, in the illustrated embodiment, the concrete mixture 1682 and the curing agent 1684 are simultaneously sprayed from a dispensing head 1604. As can be appreciated, in some embodiments, the dispensing head 1604 may comprise a spray head, and may further comprise a nozzle.

Various curing agents 1684 may be used. In some embodiments, the curing agent comprises carbon dioxide, or comprises a calcium compound. In some embodiments, the curing agent 1684 is mixed with the concrete mixture 1682 prior to being dispensed from the dispensing head 1604. In other embodiments, the curing agent 1684 and the concrete mixture 1682 are mixed as they are being dispensed.

Simultaneously spraying a curing agent 1684 and a concrete mixture 1682 may provide various advantages. For example, in some embodiments, simultaneously spraying a curing agent 1684 and a concrete mixture 1682 may increase or otherwise accelerate the curing of the concrete mixture 1682. In the illustrated embodiment, the curing agent 1684 may cause the concrete mixture 1682 being sprayed to rapidly cure or substantially cure as it contacts a surface to form a first concrete layer almost immediately. As such, additional layers (e.g., a second layer, third layer, etc.) of concrete mixtures 1682 may continuously and/or immediately be sprayed on top of the first concrete layer to build up and form a concrete wall or similar structure.

Various construction methods, e.g., methods of forming concrete structures, are also provided herein. In particular, it is contemplated that any of the components, principles, and/or embodiments discussed above may be utilized by either a system or a method. For example, in an embodiment, a construction method comprises a step of dispensing a first plurality of discrete units from a concrete dispensing assembly, wherein each of the discrete units comprises a mixture of cement, concrete aggregate, and water. The method further comprises a step of controlling one or more dispensing parameters of the concrete dispensing assembly with a computer control system.

In another embodiment, a construction method comprises a step of dispensing a plurality of discrete units from a concrete dispensing assembly, wherein each of the discrete units comprises at least one of cement and concrete aggregate. The method further comprises a step of dispensing a discrete amount of water to each of the discrete units. Still further, the method may comprise a step of mixing each discrete unit with a discrete amount of water to form a plurality of discrete concrete mixtures.

In another embodiment, a construction method comprises a step of dispensing a plurality of discrete units from a concrete dispensing assembly, wherein each of the discrete units comprises cement, concrete aggregate, and water. The method further comprises a step of covering each of the discrete units with a skin-like material.

In another embodiment, a method of manufacturing a concrete structure comprises a step of dispensing a first concrete mixture to form a first concrete layer, and a step of dispensing a second concrete mixture to form a second concrete layer, wherein the first concrete mixture has a different composition from the second concrete mixture, and the first and second concrete mixtures are dispensed simultaneously from a concrete dispensing assembly.

In another embodiment, a method of manufacturing a concrete structure comprises a step of dispensing a concrete mixture and a step of dispensing a curing agent that comprises carbon dioxide, wherein the curing agent is configured to increase the curing rate of the concrete mixture, wherein the concrete mixture and the curing agent are dispensed simultaneously. In some embodiment, the step of dispensing the concrete mixture comprises spraying the concrete mixture to form a first concrete layer. Other methods are also contemplated.

References to approximations are made throughout this specification, such as by use of the terms “substantially.” For each such reference, it is to be understood that, in some embodiments, the value, feature, or characteristic may be specified without approximation. For example, where qualifiers such as “about” and “substantially” are used, these terms include within their scope the qualified words in the absence of their qualifiers. For example, where the term “substantially circular” is recited with respect to a feature, it is understood that in further embodiments the feature can have a precisely circular configuration.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. The scope of the invention is therefore defined by the following claims.

What is claimed is:

1. A method of manufacturing a concrete structure, comprising:
dispensing a first concrete mixture to form a first concrete layer; and
dispensing a second concrete mixture to form a second concrete layer;
wherein the first concrete mixture has a different composition from the second concrete mixture, and the first and second concrete mixtures are dispensed simultaneously from a concrete dispensing assembly.

2-30. (canceled)

31. The method of claim 1, wherein at least one dispensing parameter is controllable.

32-35. (canceled)

36. The method of claim 31, wherein at least one dispensing parameter is controllable by a computer control system.

37-47. (canceled)

48. The method of claim 1, wherein the first and second concrete layers are formed in a predetermined pattern.

49-57. (canceled)

58. The method of claim 1, further comprising:
dispensing an additive.

59-63. (canceled)

64. The method of claim 58, wherein dispensing the additive comprises dispensing a curing agent.

65. The method of claim 64, wherein the curing agent comprises carbon dioxide.

66. The method of claim 64, wherein the curing agent comprises carbon dioxide clathrate.

67. The method of claim 64, wherein the curing agent comprises dry ice.

68-72. (canceled)

73. The method of claim 58, wherein dispensing the additive comprises dispensing a reinforcement member.

74-89. (canceled)

90. The method of claim 1, further comprising:
accelerating the curing of a portion of at least one of the first and second concrete mixtures.

91. The method of claim 90, wherein accelerating the curing of a portion of at least one of the first and second concrete mixtures comprises spraying the portion with a curing agent.

92-97. (canceled)

98. The method of claim 91, wherein the curing agent comprises carbon dioxide.

99. The method of claim 91, wherein the curing agent comprises carbon dioxide clathrate.

100-101. (canceled)

102. The method of claim 1, further comprising:
controlling the curing rate of at least one of the first and second concrete mixtures.

103. (canceled)

104. The method of claim 102, wherein controlling the curing rate comprises dispensing cement powder into at least one of the first and second concrete mixtures.

105-109. (canceled)

110. The method of claim 104, wherein dispensing the cement powder comprises spraying the cement powder onto the surface of at least one of the first and second concrete mixtures.

111. The method of claim 110, wherein spraying the cement powder comprises spraying a mixture comprising cement powder and a fluidizing agent.

112-113. (canceled)

114. A system for manufacturing a concrete structure, comprising:
a concrete dispensing assembly that is configured to simultaneously dispense a first concrete mixture to form a first concrete layer and a second concrete mixture to form a second concrete layer, wherein the first concrete mixture has a different composition from the second concrete mixture.

115-143. (canceled)

144. The system of claim 114, wherein at least one dispensing parameter of the concrete dispensing assembly is controllable.

145-148. (canceled)

149. The system of claim 144, wherein at least one dispensing parameter of the concrete dispensing assembly is controllable by a computer control system.

150-160. (canceled)

161. The system of claim 114, wherein the concrete dispensing assembly is configured to dispense the first and second concrete mixtures to form first and second concrete layers in a predetermined pattern.

162-170. (canceled)

171. The system of claim 114, wherein the concrete dispensing assembly is further configured to dispense an additive.

172-175. (canceled)

176. The system of claim 171, wherein the additive comprises a curing agent.

177. The system of claim 176, wherein the curing agent comprises carbon dioxide.

178. The system of claim 176, wherein the curing agent comprises carbon dioxide clathrate.

179. The system of claim 176, wherein the curing agent comprises dry ice.

180-184. (canceled)

185. The system of claim 171, wherein the additive comprises a reinforcement member.

186-201. (canceled)

202. The system of claim 114, wherein the concrete dispensing assembly is further configured to dispense a curing agent that is configured to accelerate the curing of a portion of at least one of the first and second concrete mixtures.

203. The system of claim 202, wherein the curing agent is sprayed onto a portion of at least one of the first and second concrete layers.

204-209. (canceled)

210. The system of claim 203, wherein the curing agent comprises carbon dioxide.

211. The system of claim 203, wherein the curing agent comprises carbon dioxide clathrate.

212-213. (canceled)

214. The system of claim 114, wherein the curing rate of at least one of the first and second concrete mixtures is configured to be controllable.

215. The system of claim 214, wherein the curing rate is controllable by dispensing cement powder into at least one of the first and second concrete mixtures.

216-220. (canceled)

221. The system of claim 215, wherein the cement powder is configured to be sprayed onto the surface of at least one of the first and second concrete mixtures.

222. The system of claim 221, wherein cement powder that is configured to be sprayed comprises a mixture comprising cement powder and a fluidizing agent.

223-224. (canceled)

225. A method of manufacturing a concrete structure, comprising:
dispensing a concrete mixture;
dispensing a curing agent that comprises carbon dioxide, wherein the curing agent is configured to increase the curing rate of the concrete mixture;
wherein the concrete mixture and the curing agent are dispensed simultaneously.

226. The method of claim 225, wherein the curing agent comprises carbon dioxide clathrate.

227-228. (canceled)

229. The method of claim 225, wherein the concrete mixture and the curing agent are simultaneously sprayed from a spray head.

230-231. (canceled)

232. The method of claim 225, wherein dispensing the concrete mixture comprises spraying the concrete mixture to form a first concrete layer, and wherein the curing rate of the first concrete layer is accelerated by the curing agent.

233. The method of claim 232, wherein a second concrete layer may be sprayed onto the first concrete layer immediately after spraying the first concrete layer.
